(19) United States
(12) Patent Application Publication
(10) Pub. No.: US 2022/0084265 A1
(43) Pub. Date: Mar. 17, 2022

(54) RENDERING ANTIALIASED CURVES USING DISTANCE TO CIRCLE ARCS

(71) Applicant: Unity IPR ApS, Copenhagen (DK)

(72) Inventors: Shanti Gaudreault, Saint-Lambert (CA); Martin Côté, Saint-Philippe (CA)

(21) Appl. No.: 17/473,780

(22) Filed: Sep. 13, 2021

Related U.S. Application Data
(60) Provisional application No. 63/077,404, filed on Sep. 11, 2020.

(51) Int. Cl. G06T 11/20; G06T 11/40

(52) U.S. Cl. CPC G06T 11/203; G06T 11/40

(57) ABSTRACT

A method of rendering a simple polygon is disclosed. Data describing a curve is accessed. One or more circle arc segments that fit the curve are generated. The generating includes repeatedly subdividing the curve until a difference between each subdivision of the curve and an associated circle arc segment of the one or more circle arc segments falls below a difference threshold. For each generated circle arc segment, the generating of the simple polygon is performed such that the simple polygon encompasses the circle arc segment.

### CROSS-REFERENCE TO RELATED APPLICATIONS

This application claims the benefit U.S. Provisional Application No. 63/077,404, filed Sep. 11, 2020, which is incorporated by reference herein in its entirety.

### TECHNICAL FIELD

The subject matter disclosed herein generally relates to the technical field of computer graphics systems, and in one specific example, to computer systems and methods for rendering curves.

### BACKGROUND OF THE INVENTION

In the world of computer graphics and rendering, there is a challenge in achieving smooth antialiased curves on a pixelated display. Achieving good quality curve rendering on a pixel grid is challenging and often relies on polygonal approximation. Moreover, finding pixel coverage from a curve definition is a problem that is computationally expensive to evaluate accurately. Furthermore, many antialiasing solutions require expensive supersampling buffers and/or complex shaders. Also, many “signed distance” solutions require computationally expensive pre-baked texture to store distances.

### BRIEF DESCRIPTION OF THE DRAWINGS

Features and advantages of example embodiments of the present disclosure will become apparent from the following detailed description, taken in combination with the appended drawings, in which:

FIG. 1 is a schematic illustrating a circle arc curve rendering system, in accordance with one embodiment;

FIG. 2 is a schematic illustrating a method for rendering an object defined by a curve using a circle arc curve rendering system, in accordance with one embodiment;

FIG. 3A is a flowchart illustrating a method for rendering one or more simple polygons to a display that includes a plurality of pixels, in accordance with one embodiment;

FIG. 3B is a flowchart illustrating a method for rendering an inside of an object to a display that includes a plurality of pixels, in accordance with one embodiment;

FIG. 3C is a flowchart illustrating a method for rendering an outside of an object to a display that includes a plurality of pixels, in accordance with one embodiment;

FIG. 4 is a schematic illustrating a method for rendering a line drawing of an object defined by a curve using a circle arc curve rendering system, in accordance with one embodiment;

FIG. 5 is a flowchart illustrating a method for rendering a line to a display that includes a plurality of pixels, in accordance with one embodiment;

FIG. 6A is an illustration of a circle arc segment, in accordance with an embodiment;

FIG. 6B is an illustration of a curve and two associated matched circle arc segments, in accordance with an embodiment;

FIG. 6C is an illustration of a circle arc segment and associated polygon, in accordance with an embodiment;

FIG. 7 is a block diagram illustrating an example software architecture, which may be used in conjunction with various hardware architectures described herein; and

FIG. 8 is a block diagram illustrating components of a machine, according to some example embodiments, configured. to read instructions from a machine-readable medium (e.g., a machine-readable storage medium) and perform any one or more of the methodologies discussed herein.

It will be noted that throughout the appended drawings, like features are identified by like reference numerals.

### DETAILED DESCRIPTION

The description that follows describes example systems, methods, techniques, instruction sequences, and computing machine program products that comprise illustrative embodiments of the disclosure, individually or in combination. In the following description, for the purposes of explanation, numerous specific details are set forth in order to provide an understanding of various embodiments of the inventive subject matter. It will be evident, however, to those skilled in the art, that various embodiments of the inventive subject matter may practiced without these specific details.

The term ‘content’ used throughout. the description herein should be understood to include all forms of media content items, including images, videos, audio, text, 3D models (e.g., including textures, materials, meshes, and more), animations, vector graphics, and the like.

The term ‘game’ used throughout the description herein should be understood to include video games and applications that execute and present video games on a device, and applications that execute and present simulations on a device. The term ‘game’ should. also be understood to include programming code (either source code or executable binary code) which is used to create and execute the game on a device.

The term ‘environment’ used throughout the description herein should be understood to include 2D digital environments (e.g., 2D video game environments, 2D simulation environments, 2D content creation environments, and the like), 3D digital environments (e.g., 3D game environments, 3D simulation environments, 3D content creation environments, virtual reality environments, and the like), and augmented reality environments that include both a digital (e.g., virtual) component and a real-world component.

The term ‘digital object’, used throughout the description herein is, understood to include any object of digital nature, digital structure or digital element within an environment. A digital object can represent (e.g., in a corresponding data structure) almost anything within the environment; including 3D models (e.g., characters, weapons, scene elements (e.g., buildings, trees, cars, treasures, and the like)) with 3D model textures, backgrounds (e.g., terrain, sky, and the like), lights, cameras, effects (e.g., sound and visual), animation, and more. The term ‘digital object’ may also be understood to include linked groups of individual digital objects. A digital object is associated. with data that describes properties and behavior for the object.

The terms ‘asset’, ‘game asset’, and ‘digital asset’, used throughout the description herein are understood to include any data that can be used to describe a digital object or can be used to describe an aspect of a digital project (e.g., including: a game, a film, a software application) For example, an asset. can include data for an image, a 3D model (textures, rigging, and the like), a group of 3D models (e.g., an entire scene), an audio sound, a video, animation, a 3D mesh and. the like. The data describing an asset may be stored within a file, or may be contained within a collection of files, or may be compressed and stored in one file (e.g., a compressed file), or may be stored within a memory. The data describing an asset can be used to instantiate one or more digital objects within a game at runtime (e.g., during execution of the game).

Throughout the description. herein, the term ‘mixed reality’ (MR) should be understood to include all combined environments in the spectrum between reality and virtual reality (VR) including virtual reality, augmented reality (AR) and augmented virtuality.

A method of rendering a simple polygon is disclosed. Data describing a curve is accessed. One or more circle arc segments that fit the curve are generated generating includes repeatedly subdividing the curve until a difference between each subdivision of the curve and an associated circle arc segment of the one or more circle arc segments falls below a difference threshold. For each generated circle arc segment, the generating of the simple polygon is performed such that the simple polygon encompasses the circle arc segment.

The present invention includes apparatuses which perform one or more operations or one or more combinations of operations described herein, including data processing systems which perform these methods and computer readable media which when executed on data processing systems cause the systems to perform these methods, the operations or combinations of operations including non-routine and unconventional operations or combinations of operations.

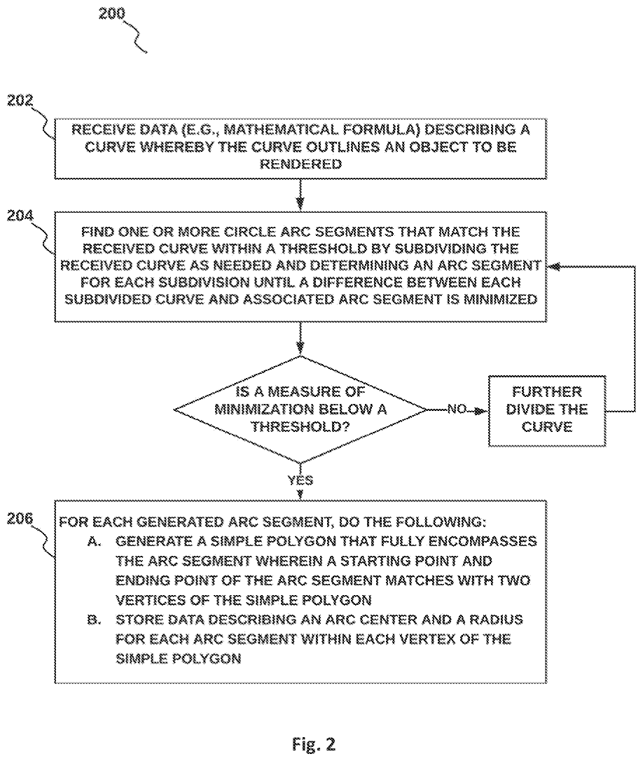

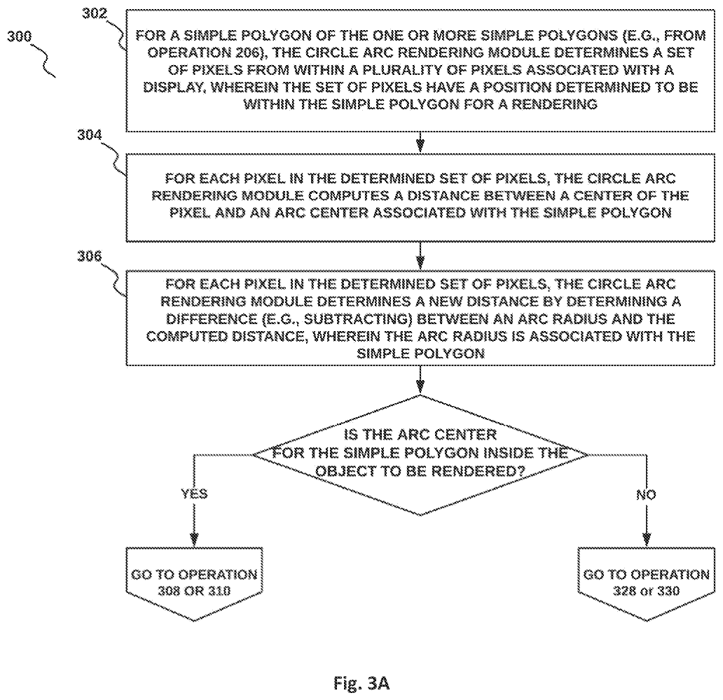

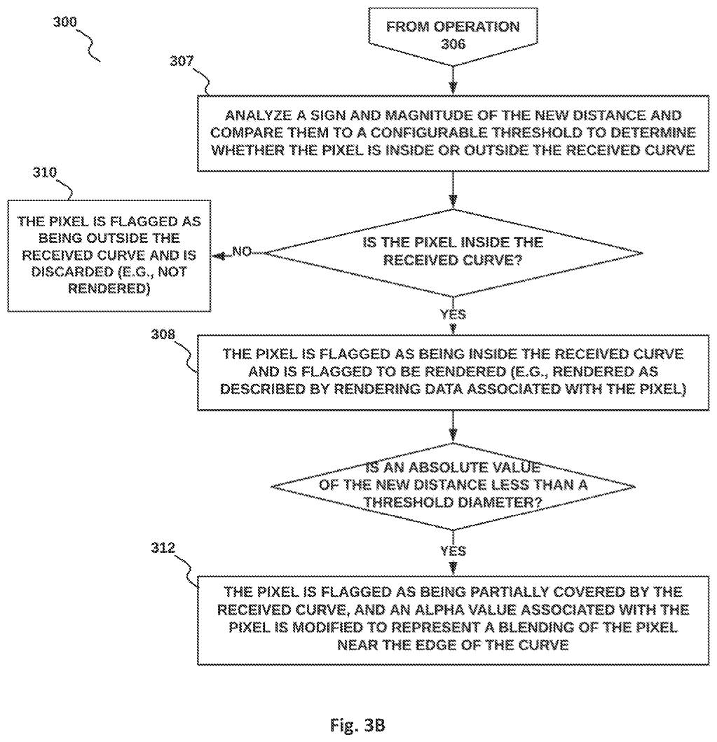

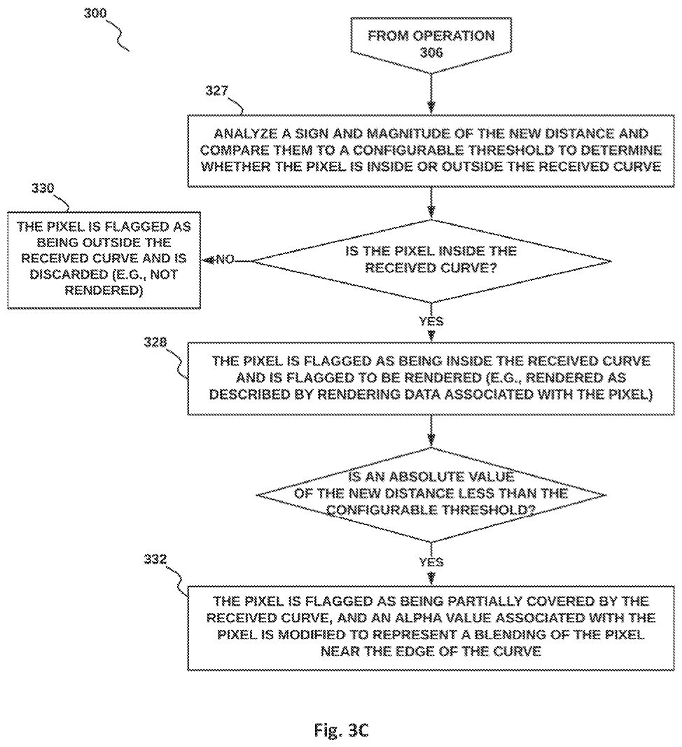

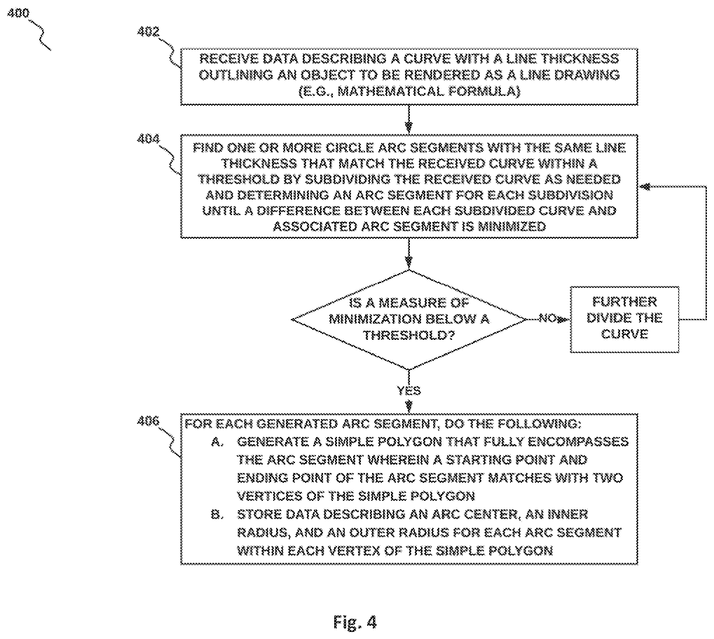

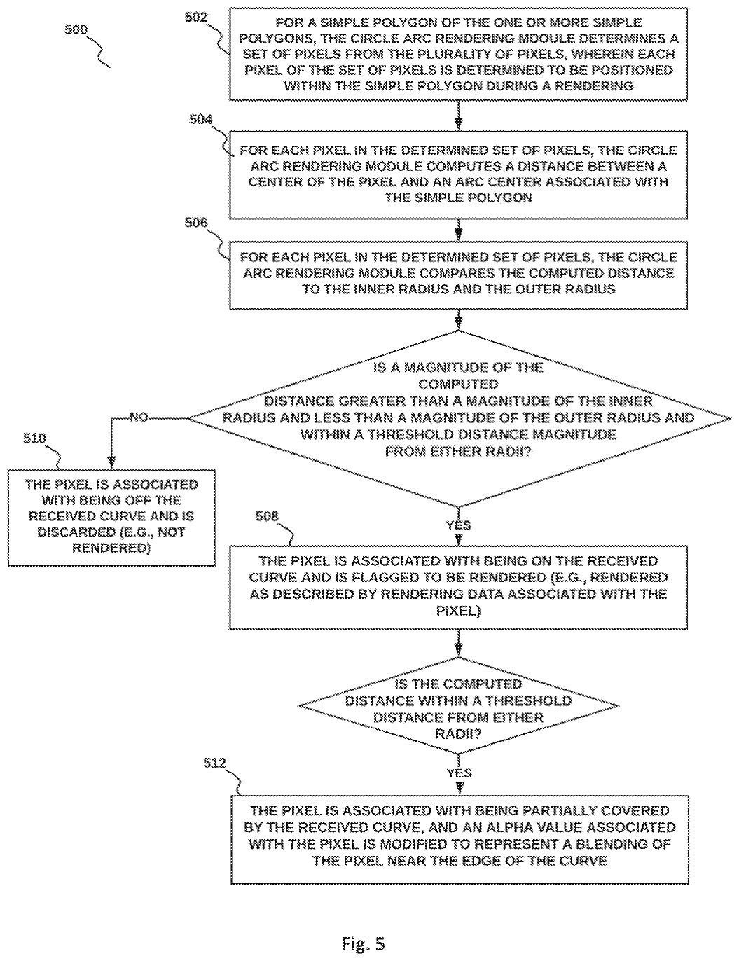

The systems and methods described herein include one or more components or operations that are non-routine or unconventional individually or when combined with one or more additional components or operations, because, for example, they provide a number of valuable benefits when rendering curves in graphical software. For example, the systems and methods described herein. simplify a rendering of curves by allowing curves to be rendered at any precision without polygonal approximations. In addition, the systems and methods described herein provide a computationally simple process for finding pixel coverage for high quality anti-aliasing. Furthermore, once curve subdivision into circle arc segments is completed. (e.g., within operations 204 and 404 as described with respect to FIG. 2 and FIG. 4 respectively), the methods and systems described with respect to FIG. 2, FIG. 3A, FIG. 3B, FIG. 3C, FIG. 4, and FIG. 5 can draw curves of any complexity in a computationally efficient manner since only a couple of distances are evaluated per pixel, resulting in a displayed smooth curve that includes a high sub-pixel accuracy for antialiasing. The systems and. methods described herein are computationally lightweight since they can evaluate a signed distance within a shader using a simple point-to-point distance (e.g., as calculated in operations 204 and 404), thus eliminating a need for computationally expensive pre-baked textures to store the distances. Given that many antialiasing solutions require computationally expensive supersampling buffers and/or complex shaders, the systems and methods described herein provide more visually accurate results with less computational complexity.

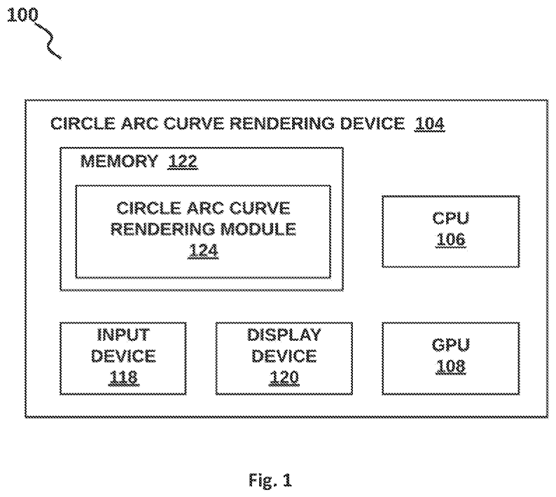

Turning now to the drawings, systems and methods, including non-routine or unconventional components or operations, or combinations of such components or operations, for rendering curves with circle arcs in accordance with embodiments of the invention are illustrated. Accordingly, FIG. 1 is a diagram of an example circle arc curve rendering system 100 and associated device 104 configured to provide circle arc curve rendering system functionality. In the example embodiment, the circle arc curve rendering system 100 includes a circle arc curve rendering device 104. In some embodiments, the circle arc curve rendering device 104 is a mobile computing device, such as a smartphone, a tablet computer, a laptop computer, a head mounted virtual reality (VR) device or a head mounted augmented reality (AR) device capable of providing a mixed reality experience to a user. In other embodiments, the circle arc curve rendering device 104 is a computing device such as a desktop computer.

In the example embodiment, the circle arc curve rendering device 104 includes one or more central processing units (CPUs) 106, and graphics processing units (GPUs) 108. The processing device 106 is any type of processor, processor assembly comprising multiple processing elements (not shown), having access to a memory 122 to retrieve instructions stored thereon, and execute such instructions. Upon execution of such instructions, the instructions implement the processing device 106 to perform a series of tasks as described herein in reference to FIG. 2, FIG. 3A, FIG. 3B, FIG. 3C, FIG. 4, and FIG. 5.

The circle arc curve rendering device 104 also includes one or more input devices 118 such as, for example, a keyboard or keypad, a mouse, a pointing device, a touchscreen, a hand-held device (e.g., hand motion tracking device), a microphone, a camera, and the like, for inputting information in the form of a data signal readable by the processing device 106. The circle arc curve rendering device 104 further includes one or more display devices 120, such as a touchscreen of a tablet or smartphone, or lenses or visor of a VR or AR HMD, or a computer monitor which may be configured to display virtual objects (e.g., to a user). The display device 120 may be driven or controlled by one or more GPUs 108. The GPU 108 processes aspects of graphical output that assists in speeding up rendering of output through the display device 120.

The circle arc curve rendering device 104 also includes a memory 122 configured to store a circle arc curve rendering module 124 configured to perform operations as described with respect to FIG. 2, FIG. 3A, FIG. 3B, FIG. 3C, FIG. 4, and FIG. 5. The memory 122 can be any type of memory device, such as random access memory, read only or rewritable memory, internal processor caches, and the like. In accordance with an embodiment, though not shown in FIG. 1, the memory 122 may be further divided into a local storage device for storing data (e.g., including a hard disk drive, an SSD drive and memory sticks) and a local cache memory for quick retrieval of data (e.g., RAM memory, CPU memory, and CPU cache).

In accordance with an embodiment, the memory 122 may also store a game engine (e.g., executed by the CPU 106 or GPU 108) that communicates with the display device 120 and also with. other hardware such as the input/output device(s) 118 to present digital content to a user. The game engine would typically include one or more modules that provide the following: simulation of a virtual environment and digital objects therein (e.g., including animation of digital objects, animation physics for digital objects, collision detection for digital objects, and the like), rendering of the virtual environment and the digital objects therein, networking, sound, and the like in order to provide the user with a complete or partial virtual environment (e.g., including video game environment or simulation environment) via the display device 120. In accordance with an embodiment, the simulation and rendering of the virtual environment may be de-coupled, each being performed independently and concurrently, such that the rendering always uses a recent state of the virtual environment and current settings of the virtual environment to generate a visual representation at an interactive frame rate and, independently thereof, the simulation step updates the state of at least some of the digital objects (e.g., at another rate).

### Rendering a Solid Object

In accordance with. an embodiment, FIG. 2 shows a method 200 for rendering an object defined by a curve using a circle arc segment. The method 200 may be used in conjunction with the circle arc curve rendering system 100 as described with respect to FIG. 1. In various embodiments, some of the method elements shown may be performed concurrently, in a different order than shown, or may be omitted. The method 200 can achieve smooth and antialiased curves at any zoom level (e.g., at an arbitrary close up level). In accordance with an embodiment, at operation 202 of the method, the circle arc curve rendering module 124 receives a definition of a curve. For example, the curve definition may include a mathematical formula that describes the curve. The curve may be any curve type, including but not limited to quadratic curves (e.g., quadratic Bezier) and cubic curves (e.g., cubic Bezier). In accordance an embodiment, the received curve defines a boundary of an object to be rendered on a pixelated display. In accordance with an embodiment, the curve may include a plurality of connected smaller curves that defines the object. In accordance with an embodiment, the object may be rendered as a solid object with the curve representing the boundary of a rendering of the object (e.g., a boundary of texture and color).

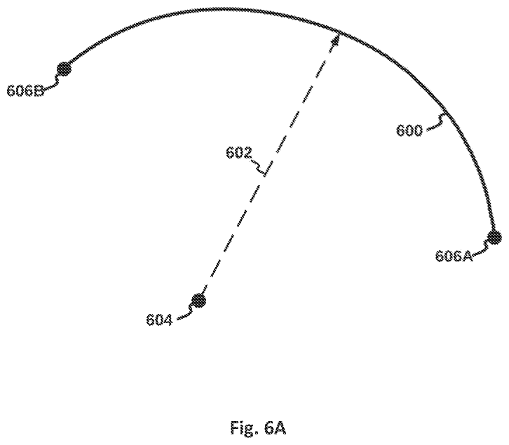

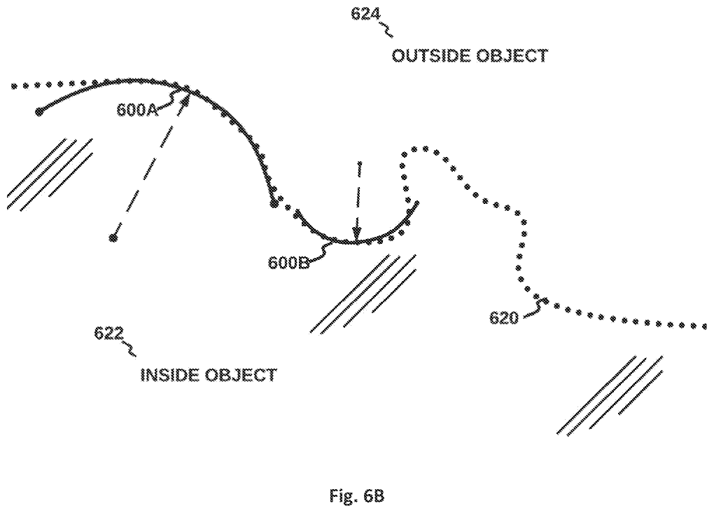

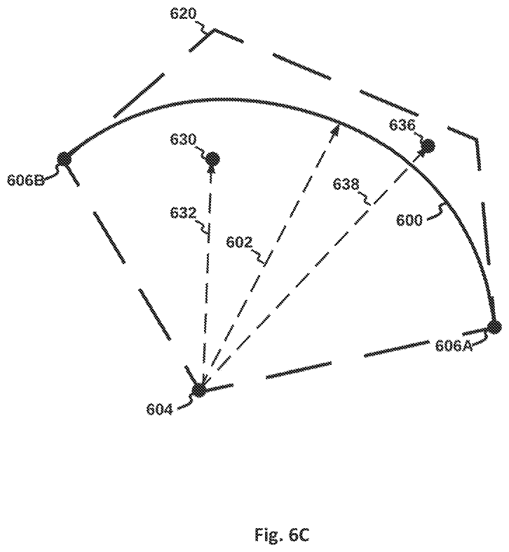

In accordance with an embodiment, at operation 204 of the method 200, the circle arc curve rendering module 124 determines one or more circle arc segments that best match the received curve (e.g., using a curve fitting method). A circle arc segment of the one or more circle arc segments may be described with a center point, a radius, along with a start and end point for the arc (details of a circle arc segment are shown and described with respect to FIG. 6A). In accordance with an embodiment, for each circle arc segment of the one or more circle arc segments, one or more of the radius, the center point, the start point and the end point of the circle arc segment may be modified (e.g., during the curve fitting) in order to minimize a difference between the circle arc segment and the received curve. In accordance with an embodiment, as part of operation 204, the circle arc curve rendering module 124 subdivides the received curve into a plurality or sections and generates a circle arc segment for each section of the plurality of sections until a difference between a section of the plurality of sections and a circle arc segment for the section is below a configurable difference threshold (e.g., near zero). In accordance with an embodiment, operation 204 may be an iterative process that involves dividing the received curve into a plurality of sections, generating a plurality of arc segments for each section of the divided curve (the generated arc segments may include using a curve fitting algorithm to fit the arc to the curve section by modifying a radius, a center point, a start point and an end point of the circle arc segment), testing a fitting of each arc segment to an associated section of the divided curve, and further dividing the divided curve into smaller sections based on a failure of the fitting test.

In accordance with an embodiment, at operation 206 of the method 200, for each generated arc segment, the circle arc curve rendering module 124 generates a simple polygon that fully encompasses the arc segment. For example, the simple polygon may include a triangle or quadrilateral. In accordance with an embodiment, the simple polygon is generated so that a starting point and an ending point associated with the encompassed arc segment coincides (e.g., are in the same location or overlap) with two vertices of the simple polygon. In accordance with an embodiment, the simple polygon is generated so that the encompassed arc segment is completely within bounds of the simple polygon. In accordance with an embodiment, and as part of operation 206, the circle arc curve rendering module 124 stores data describing an arc center (e.g., 3D coordinates) and a radius associated with the encompassed arc segment within each vertex of the generated simple polygon. For example, the data describing the arc center may be stored with data describing the vertex. In accordance with an embodiment, as part of operation 206, the circle arc curve rendering module 124 may store additional data in a vertex, the additional data including information on a relative position of the arc center with respect to the object to be rendered. The additional data may describe whether the arc center is inside the object to be rendered, or outside the object to be rendered. For example, a positive or negative sign of the arc radius stored in the vertex may be used to signal the relative position of the arc center, with one of the signs representing an arc center outside the object (e.g., see 600B in FIG. 6B) to be rendered and the other sign representing an arc center inside the object (e.g., see 600A in FIG. 6B) to be rendered.

In accordance with an embodiment, FIG. 3 is a flowchart of a method 300 for rendering one or more simple polygons created in operation 206 to a display that includes a plurality of pixels (e.g., a display screen that may display raster graphics). In accordance with an embodiment, the method 300 may be used when rendering a shape (e.g., an object or part of an object) within an environment (e.g., a 3D environment), wherein the shape includes a boundary defined by the received curve (e.g., received in operation 202) and wherein an inside of the shape is being rendered (e.g., rendering a solid object). In various embodiments, some of the method elements shown may be performed concurrently, in a different order than shown, or may be omitted. In accordance with an embodiment, at operation 302 of the method 300, for a simple polygon of the one or more simple polygons of operation 206, the circle arc curve rendering module 124 determines a set of pixels from the plurality of pixels in the display that are within the simple polygon for a rendering. The rendering may include a rendering of a view (e.g., a view frustum from a virtual camera) of the environment that includes the curve and the simple polygon. In accordance with an embodiment, at operation 304 of the method 300, for each pixel in the determined set of pixels, the circle arc curve rendering module 124 computes a distance ‘d’ between a center of the pixel and an arc center associated with the simple polygon (e.g., wherein the arc center is associated with an arc segment that is associated with the simple polygon as determined in operation 206 and stored within a vertex of the simple polygon). In accordance with an embodiment, the distance ‘d’ may be determined with respect to pixels within the display and may be in pixel units. In accordance with another embodiment, the distance ‘d’ may be in a normalized unit of measure (e.g., based on a use of a normalized coordinate system for the environment, including coordinates that define the received curve and coordinates that define an arc segment).

In accordance with an embodiment, at operation 306 of the method 300, for each pixel in the determined set of pixels associated with a simple polygon, the circle arc curve rendering module 124 determines a new distance ‘d_new’, wherein the new distance represents a difference between an arc radius (e.g., an arc radius value associated with the simple polygon) and the computed distance ‘d’. For example, the new distance may be determined by subtracting an arc radius from the computed distance ‘d’ (e.g., d_new=d−arc radius or d_new=arc radius−d). In accordance with an embodiment, a value for the computed distance ‘d’ and a value for the arc radius may both be positive values (e.g., using an absolute value operation) that represent magnitudes such that the new distance ‘d_new’ represents a distance between the pixel and the arc segment associated with the simple polygon, and wherein a positive value of the new distance represents a pixel positioned on the same side of the arc segment as is the center point for the arc segment, and wherein a negative value of the new distance represents a pixel positioned on the opposite side of the arc segment as is the center point for the arc segment. In accordance with an embodiment, the new distance may be computed in other ways, such as computations with 3D coordinates using linear algebra. In accordance with an embodiment, as part of operation 306, the additional data in a vertex (e.g., the additional data representing a sign of arc radius stored in the vertex during operation 206) is used to determine whether an arc center associated with the vertex is inside or outside the object to be rendered.

In accordance with an embodiment, FIG. 3B is a continuation of FIG. 3A, showing an illustration of a flowchart for rendering the object to be rendered wherein an arc center is inside the object to be rendered (as determined in operation 306). An example arc center inside an object to be rendered is shown as 600A in FIG. 6B. In accordance with an embodiment, at operation 307 of the method 300, an analysis of a magnitude and a sign (e.g., positive or negative) of the new distance is performed to determine whether the pixel associated with the new distance is inside the curve (e.g., inside the object). A sign of the new distance may be associated with an inside of the object or an outside of the object based on an order of subtraction for a computation of the new distance (e.g., whether d_new=d−arc radius or d_new=arc radius−d). For example, at operation 308, based on the pixel being determined to be inside the received curve, the pixel associated with the new distance is flagged as being inside the received curve and is flagged to be rendered. For example, and based on d_new=d−arc radius, and based on the new distance having a value less than a configurable distance threshold (e.g., including negative values), the pixel associated with the new distance is flagged as being inside the received curve (e.g., based on the distance threshold being 0.5 pixel units, a pixel within half a pixel distance from an inside of the object to be rendered may be flagged as being within the object) and is flagged to be rendered (e.g., the pixel is to be used in rendering according to lighting, textures, etc. associated with the pixel). Alternatively, based on d_new=arc radius−d, and based on the new distance having a positive value or negative value greater than a configurable distance threshold, the pixel associated with the new distance is fagged as being inside the received curve and is flagged to be rendered. While a distance threshold in pixel units (e.g., 0.5 pixel units) might be convenient for a pixel display, it should be understood that any distance unit may be used for the distance threshold.

In accordance with an embodiment, at operation 310 of the method 300, based on the pixel being determined to be outside the received curve, the pixel associated with the new distance is flagged as being outside the received curve and is flagged to be ignored during rendering. For example, based on d_new=d−arc radius, and based on the new distance being more than the configurable distance threshold (e.g., positive and with a magnitude greater than the configurable distance threshold), the pixel is flagged as being outside the received curve (e.g., based on the distance threshold being 0.5 pixel units, a pixel that is farther than half a pixel distance outside of the object to be rendered may be flagged as being outside the object) and is discarded or ignored during rendering (e.g., the pixel is not rendered). Alternatively, and in accordance with an embodiment, at operation 310 of the method 300, based on d_new=arc radius−d, and based on the new distance being less than the configurable distance threshold (e.g., negative and with a magnitude greater than the configurable distance threshold), the pixel is flagged as being outside the received curve and is discarded or ignored during rendering.

In accordance with an embodiment, at operation 312 of the method 300, based on an absolute value of the new distance being less than the configurable distance threshold, the pixel may be flagged as being partially covered by the received curve (e.g., partially on the received curve), and an alpha value (e.g., transparency value) associated with the pixel may be modified to represent a blending or smoothing of the pixel near the curve. For example, the alpha value may be modified so that the value drops close to zero towards an outside of the received curve while it increases to 1 towards an inside of the received curve. For example, the following formula may be used when the new distance value is between a negative and positive distance threshold value (e.g., which represents the absolute value range) such as −0.5 and +0.5 pixel units: alpha value=d_new+0.5. While a measure of 0.5 pixel units is shown above as an example for operation 312, it should be understood that other units of distance and other values may be used.

In accordance with an embodiment, FIG. 3C is a continuation of FIG. 3A, showing an illustration of a flowchart for rendering the object to be rendered wherein an arc center is outside the object to be rendered (as determined in operation 306). An example arc center outside an object to be rendered is shown as 600B in FIG. 6B. In accordance with an embodiment, at operation 327 of the method 300, an analysis of a magnitude and a sign (e.g., positive or negative) of the new distance is performed to determine whether the pixel associated with the new distance is inside the received curve (e.g., inside the object). For example, at operation 328, based on the pixel being determined to be inside the received curve, the pixel associated with the new distance is flagged as being inside the received curve and is flagged to be rendered. For example, and based on d_new=d−arc radius, and based on the new distance having a positive value or with a magnitude less than the configurable distance threshold, the pixel is flagged as being inside the received curve (e.g., the pixel is within a distance threshold distance from an inside of the object to be rendered described by the curve received during operation 202) and is flagged to be rendered (e.g., the pixel to be used in rendering according to lighting, textures, etc. associated with the pixel). Alternatively, based on d_new=arc radius−d, and based on the new distance having a negative value or a positive value less than a configurable distance threshold, the pixel associated with the new distance is flagged as being inside the received curve and is flagged to be rendered.

In accordance with an embodiment, at operation 330 of the method 300, based on the pixel being determined to be outside the received curve, the pixel associated with the new distance is flagged as being outside the received curve and is flagged to be ignored during rendering. For example, based on d_new=d−arc radius, and based on the new distance being negative and more than the configurable distance threshold, the pixel is flagged as being outside the received curve (e.g., the pixel is farther than the configurable distance threshold distance outside of the object to be rendered described by the curve received during operation 202) and is discarded or ignored during rendering (e.g., the pixel is not rendered). While a distance threshold in pixel units (e.g., 0.5 pixel units) might be convenient for a pixel display, it should be understood that any distance unit may be used for the distance threshold. Alternatively, and in accordance with an embodiment, at operation 330 of the method 300, based on d_new=arc radius−d, and based on the new distance being positive and with a magnitude greater than the configurable distance threshold, the pixel is flagged as being outside the received curve and is discarded or ignored during rendering.

In accordance with an embodiment, at operation 332 of the method 300, based on a magnitude of the new distance being less than the configurable distance threshold, the pixel may be flagged as being partially covered by the received curve (e.g., partially on the received curve), and an alpha value (e.g., transparency value) associated with the pixel is modified to represent a blending or smoothing of the pixel near the curve. For example, the alpha value may be modified so that the value drops close to zero towards an outside of the received curve while it increases to 1 towards an inside of the received curve. For example, the following formula may be used when the new distance value is between a negative and positive value of a configurable distance threshold (e.g., −0.5 and +0.5 pixel units): alpha value=d_new+0.5. While a measure of 0.5 pixel units is shown above as an example for operation 332, it should be understood that other units of distance and other values may be used.

### Rendering a Line Drawing of an Object

In accordance with an embodiment, FIG. 4 shows a method 400 for rendering a curve using a circle arc. The method 400 can achieve smooth and antialiased curves at any zoom level (e.g., at an arbitrary close up level). In accordance with an embodiment, the method 400 is used when rendering an object (e.g., or part of an object) with a boundary defined by a received curve and wherein only the boundary of the object is being rendered (e.g., rendering a line object without rendering a filling for the object, such as a line drawing). In accordance with an embodiment, at operation 402 of the method 400, the circle arc curve rendering module 124 receives data describing a curve. In accordance with an embodiment, operation 402 may be similar to operation 202. For example, the data describing the curve may include a mathematical formula that describes the curve. The curve may be any curve type, including but not limited to quadratic curves (e.g., quadratic Bezier) and cubic curves (e.g., cubic Bezier). In accordance with an embodiment, the received curve defines a boundary of an object to be rendered on a pixelated display. In accordance with an embodiment, the curve may be a plurality of connected smaller curves that defines the object. In accordance with an embodiment, the received data describing the curve includes data describing a thickness of the curve.

In accordance with an embodiment, at operation 404 of the method, the circle arc curve rendering module 124 determines one or more circle arc segments that best matches the received curve (e.g., a best fit of a circle arc segment to the received curve). A circle arc segment of the one or more circle arc segments may be described with a center point, a radius, line thickness, along with a start and end point for the arc segment. In accordance with an embodiment, for each circle arc segment of the one or more circle arc segments, any one or more of the radius, the center point, the line thickness, the start point and the end point of a circle arc segment may be modified in order to minimize a difference between the circle arc segment and the received curve. In accordance with an embodiment, as part of operation 404, the circle arc curve rendering module 124 subdivides the received curve into a plurality of sections and generates a circle arc segment for each section of the plurality of sections until a difference between a section of the plurality of sections and a circle arc segment for the section is below a configurable difference threshold (e.g., near zero), or alternatively if a fitting factor is above a configurable fitting threshold. In accordance with an embodiment, operation 404 may be an iterative process that involves dividing the received curve into a plurality of sections, generating a plurality of arc segments for each section of the divided curve, testing a fitting of each arc segment to an associated section of the divided curve, and further dividing the divided curve based on a failure of the fitting test. In accordance with an embodiment, a thickness of an arc segment for a section of the plurality of sections may be modified to match a thickness for the curve section.

In accordance with an embodiment, at operation 406 of the method 400, for each generated arc segment, the circle arc curve rendering module 124 generates a simple polygon that fully encompasses the arc segment. In accordance with an embodiment, the simple polygon may include a triangle or quadrilateral. In accordance with an embodiment, the simple polygon is generated so that a starting point and an ending point associated with the encompassed arc segment coincides (e.g., are in the same location or overlap) with two vertices of the simple polygon. In accordance with an embodiment, the simple polygon is generated so that the encompassed arc segment is completely within bounds of the simple polygon. In accordance with an embodiment, and as part of operation 406, the circle arc curve rendering module 124 stores data describing an arc center (e.g., 3D coordinates), an inner radius, and an outer radius associated with the encompassed arc segment within each vertex of the generated simple polygon (e.g., wherein the data describing the arc center, the inner radius and the outer radius are determined in operation 404). In accordance with an embodiment, the inner radius represents a distance from the arc center to an inner edge of the received curve, while the outer radius represents a distance from the arc center to an outer edge of the received curve. The inner and outer radii representing radii from the arc center to two edges of the received curve with thickness.

In accordance with an embodiment, FIG. 5 is a flowchart of a method 500 for rendering one or more simple polygons created in operation 406 to a display that includes a plurality of pixels (e.g., a pixelated display). In accordance with an embodiment, at operation 502 of the method 500, for a simple polygon of the one or more simple polygons generated in operation 406, the circle arc curve rendering module 124 determines a set of pixels from the plurality of pixels wherein each pixel of the set of pixels is determined to be positioned within the simple polygon (e.g., with respect to a frustum view during a rendering of the received curve within the view). In accordance with an embodiment, at operation 504 of the method 500, for each pixel in the determined set of pixels, the circle arc curve rendering module 124 computes a distance ‘d’ between. a center of the pixel and an arc center associated with the simple polygon (e.g., as determined in operation 406 and stored within a vertex of the simple polygon). In accordance with an embodiment, the distance may be determined with respect to pixels within a display screen and may be in pixel units or may be in a normalized format (e.g., with respect to a normalized coordinate system). In accordance with an embodiment, the distance ‘d’ may be determined in any distance unit. In accordance with an embodiment, at operation 506 of the method 500, for each pixel in the determined set of pixels, the circle arc curve rendering module 124 compares the computed difference ‘d’ to the inner radius and the outer radius to determine if the pixel is on or touching the received curve. For example, as part of operation 506, the circle arc curve rendering module 124 may compare a magnitude of the computed distance ‘d’ to a magnitude of the inner radius and a magnitude of the outer radius.

In accordance with an embodiment, at operation 508 of the method 500, based on the magnitude of the computed distance ‘d’ being greater than a magnitude of the inner radius and less than a magnitude of the outer radius, and within a configurable threshold distance magnitude (e.g., 0.5 pixel units) from either radii, the pixel is flagged as being on the received curve (e.g., the pixel is flagged as being within a threshold distance from the received curve) and is flagged to be rendered (e.g., the pixel is to be used in a rendering according to lighting, textures, etc. associated with the pixel). While an example distance threshold value of 0.5 pixel units is described above for operation 508, it should be understood that other values of pixel units (or any other distance unit) may be used as a distance threshold. In accordance with an embodiment, at operation 510 of the method 500, based on the pixel being deemed as not being on the curve (e.g., the pixel is farther than the configurable distance threshold distance outside of the received curve), the pixel is discarded or ignored during rendering (e.g., the pixel is not rendered).

In accordance with an embodiment, at operation 512 of the method 500, based on a magnitude of the computed distance being within a configurable distance threshold magnitude from either the inner radius or the outer radius, the pixel is associated with being partially covered by the received curve (e.g., partially on the received curve), and an alpha value (e.g., transparency value) associated with the pixel is modified to represent a blending or smoothing of the pixel near the curve. For example, the alpha value may be modified so that the value drops close to zero towards the outside of the received curve while it increases to 1 towards the inside of the received curve.

In accordance with various embodiments, some of the method operations shown for the method 200 in FIG. 2, the method 300 shown in FIG. 3A, 3B, and 3C, the method 400 shown in FIG. 4, and the method 500 shown in FIG. 5 may be performed concurrently, in a different order than shown, or may be omitted.

### Scaling of Curve or Rendering View

In accordance with an embodiment, as part of operation 206 of the method 200, and as part of operation 406 of the method 400, the stored data for an arc segment may be stored in a normalized format. For example, the normalized format may include a normalized coordinate system with values ranging from 0 to 1. The storage of data in a normalized format may provide computational benefits when handling scaling operations related to a received curve (e.g., within operation 202 or 404), or a scaling of a view related to a rendering of the received curve (e.g., when a user zooms in on view of a curve). The storing of normalized data within a vertex can avoid a modification of the stored data which might be required for non-normalized data after a scaling operation. In accordance with an embodiment, circle arc segment data which is normalized may be multiplied by a scaling factor (e.g., from a scaling operation) prior to use (e.g., prior to use of the data when calculating distances in operation 304, 306, 504 and 506).

In accordance with an embodiment, based on a storing of normalized data within a vertex, the operations that determine pixel rendering for antialiasing (e.g., including operations 304 and 306 within the method 300 and operations 504 and 506 of the method 500) may be modified to accommodate the normalized data. For example, based on a storage of a normalized arc center and arc radius (e.g., instead of an arc center and radius in pixel units), computing rendering for a pixel with respect to a received curve may include a use of fragment derivatives to determine a change in distance when compared to neighboring pixels.

In accordance with an embodiment, and shown in FIG. 6A, is an illustration of a circle arc segment 600 (e.g., as used. in operations described with respect to FIG. 2, FIG. 3A, FIG. 3B, FIG. 3C, FIG. 4, and FIG. 5). In accordance with an embodiment, a circle arc segment is a segment of (e.g., a part of) a full circle. A circle arc segment 600 may include a center point 604 which may coincide with a center of the full circle. The circle arc segment 600 may include a radius 602 which represents a distance from the circle arc segment 600 to the center point 604. The circle arc segment 600 may also include a start point 606A and an end point 606B along the circle arc segment 600 representing a start and end to the circle arc. The labels for the start point 606A and the end point 606B may be interchanged.

In accordance with an embodiment, and shown in FIG. 6B is an illustration of a plurality of circle arc segments (600A and 600B) fitted to a curve 620. The fitting of the circle arc segments (600A and 600B) to the curve 620 may be part of operation 204 and 404 (described with respect to FIG. and FIG. 4 respectively). The curve 620 may be a curve received during operation 202 of the method 200 or 402 of the method 400 and may be part of a description of a digital object (e.g., a 3D object). In accordance with the example, the curve 620 shown in FIG. 6B may define an inside region 622 of an object and an outside region 624 of an object, wherein the inside 622 may be filled or colored in a rendering operation (e.g., as described in operations 308, 328 and 508). While only two circle arc segments are shown in FIG. 6B, it should be understood that any number of circle arc segments may be fitted. to the curve 620 (e.g., during operation 204 of the method 200 and 404 of the method 400). In addition, the illustrated circle arc segments 600A and 600B shown in FIG. 6B are shown for ease of understanding only and may not be optimally fitted to the illustrated curve 620.

In accordance with an embodiment, and shown in FIG. is an illustration of a circle arc segment 600 and an associated polygon 620 wherein two points of the polygon 620 coincide with a start point 606A and an end point 606B of the circle arc segment 600 and a third point of the polygon 620 coincides (e.g., are in the same location or overlap) with the center point 604 of the circle arc segment (e.g., as described in operation 206 and 406 of the methods 200 and 400, respectively). As shown. in FIG. 6C, and described in operation 206 and 406, the polygon may be generated to completely include the circle arc segment 600. In accordance with an embodiment, and as shown in FIG. 6C, there is a first pixel 630 and second pixel 636 determined to be within a set of pixels, wherein the set of pixels is described with respect to operation 302 and operation 502 of the methods 300 and 500, respectively. As described in the method 300 and 500, a distance 632 from the center point 604 to the first pixel 630 is compared to the arc radius 602 to determine whether the first pixel 630 is inside or outside an object described by a curve for which the circle arc segment 600 is fitted. Similarly, as described in the method 300 and 500, a distance 638 from the center point 604 to the second pixel 636 is compared to the arc radius 602 to determine whether the second pixel 636 is inside or outside an object described by a curve for which the circle arc segment 600 is fitted.

While illustrated in the block diagrams as groups of discrete components communicating with each other via distinct data signal connections, it will be understood by those skilled in the art that the various embodiments may be provided by a combination of hardware and software components, with some components being implemented by a given function or operation of a hardware or software system, and many of the data paths illustrated being implemented by data communication within a computer application or operating system. The structure illustrated is thus provided for efficiency of teaching the present various embodiments.

It should be noted that the present disclosure can be carried out as a method, can be embodied in a system, a computer readable medium or an electrical or electro-magnetic signal. The embodiments described above and illustrated in the accompanying drawings are intended to be exemplary only. It will be evident to those skilled in the art that modifications may be made without departing from this disclosure. Such modifications are considered as possible variants and lie within the scope of the disclosure.

Certain embodiments are described herein as including logic or a number components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. Such software may at least temporarily transform the general-purpose processor into a special-purpose processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need. not be configured or instantiated at any one instance in time. For example, where a hardware module comprises a general-purpose processor configured by software to become a special-purpose processor, the general-purpose processor may be configured as respectively different special purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

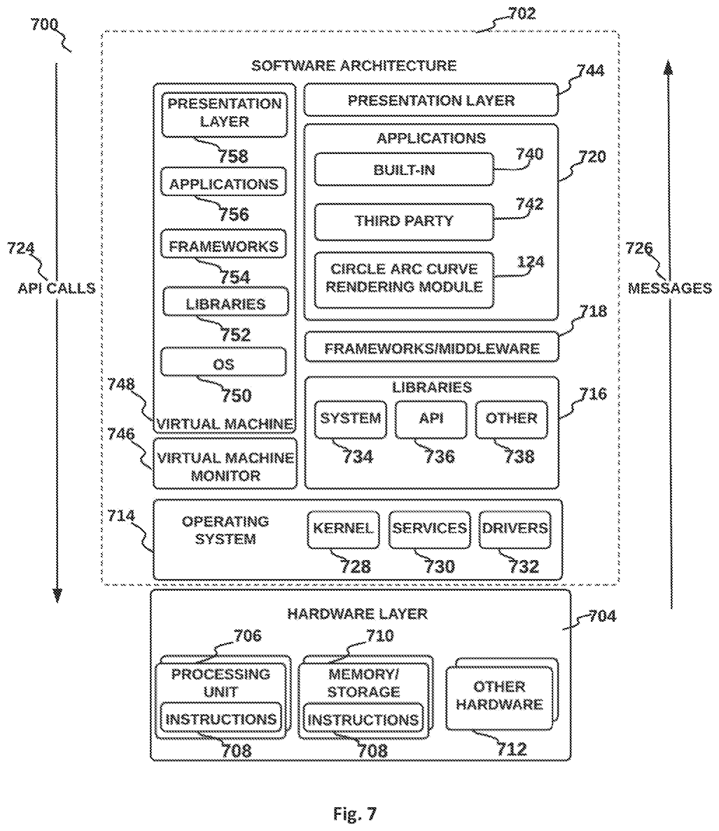

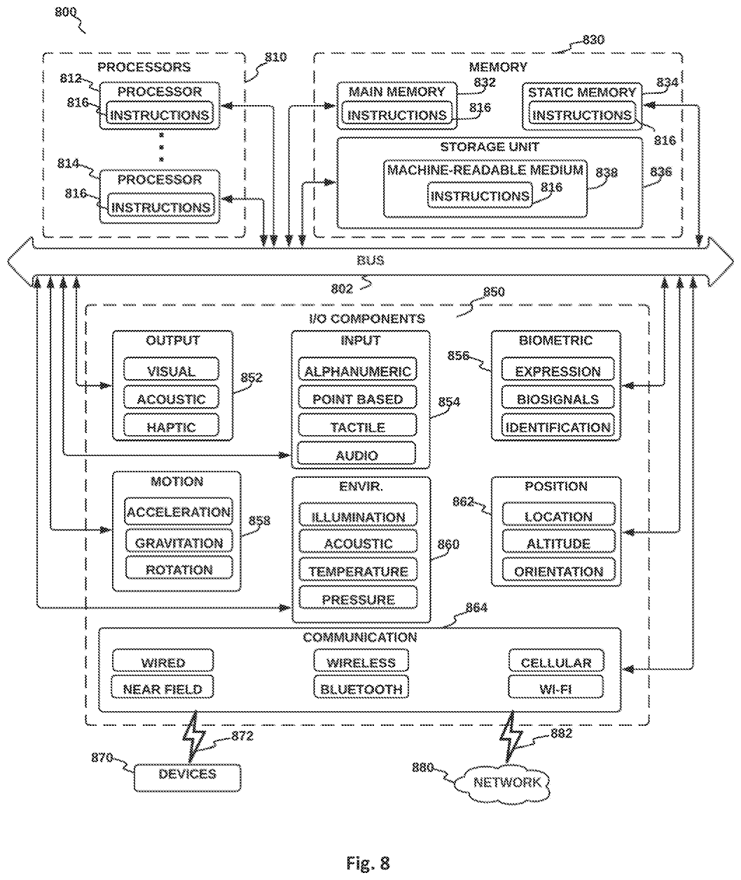

FIG. 7 is a block diagram 700 illustrating an example software architecture 702, which may be used in conjunction with various hardware architectures herein described to provide a gaming engine 701 and/or components of the circle arc curve rendering system 100. FIG. 7 is a non-limiting example of a software architecture and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 having associated executable instructions 708. The executable instructions 708 represent the executable instructions of the software architecture 702, including implementation of the methods, modules and so forth described herein. The hardware layer 704 also includes memory/storage 710, which also includes the executable instructions 708. The hardware layer 704 may also comprise other hardware 712.

In the example architecture of FIG. 7, the software architecture 702 may be conceptualized as a stack of layers where each layer provides particular functionality. For example, the software architecture 702 may include layers such as an operating system 714, libraries 716, frameworks or middleware 718, applications 720 and a presentation layer 744. Operationally, the applications 720 and/or other components within the layers may invoke application programming interface (API) calls 724 through the software stack and receive a response as messages 726. The layers illustrated are representative in nature and not all software architectures have all layers. For example, some mobile or special purpose operating systems may not provide the frameworks/middleware 718, while others may provide such a layer. Other software architectures may include additional or different layers.

The operating system 714 may manage hardware resources and provide common services. The operating, system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 716 may provide a common infrastructure that may be used by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 816 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PhD), graphics Libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred. to as middleware) provide a higher-level common infrastructure that may be used by the applications 720 and/or other software components/modules. For example, the frameworks/middleware 718 may provide various graphic user interface (GUI) functions, high-level resource management, high-level location services, and so forth. The frameworks/middleware 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. Third-party applications 742 may include any an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 742 may invoke the API calls 724 provided by the mobile operating system such as operating system 714 to facilitate functionality described herein.

The applications 720 may use built-in operating system functions (e.g., kernel 728, services 730 and/or drivers 732), libraries 716, or frameworks/middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with a user.

Some software architectures use virtual machines. In the example of FIG. 7, this is illustrated by a virtual machine 743. The virtual machine 748 creates a software environment where applications/modules can execute as if they were executing on a hardware machine (such as the machine 800 of FIG. 8, for example). The virtual machine 748 is hosted by a host operating system (e.g., operating system 714) and typically, although not always, has a virtual machine monitor 746, which manages the operation of the virtual machine 748 as well as the interface with the host operating system (i.e., operating system 714). A software architecture executes within the virtual machine 748 such as an operating system (OS) 750, libraries 752, frameworks 754, applications 756, and/or a presentation layer 758. These layers of software architecture executing within the virtual machine 748 can be the same as corresponding layers previously described or may be different.

FIG. 8 is a block diagram illustrating components of a machine 800, according to some example embodiments, configured to read instructions from a machine-readable medium (e.g., a machine-readable storage medium) and perform any one or more of the methodologies discussed herein. In some embodiments, the machine 800 is similar to the circle arc curve rendering device 104. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. As such, the instructions 816 may be used to implement modules or components described herein. The instructions transform the general, non-programmed machine into a particular machine programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines that individually or jointly execute the instructions 816 to perform any one or more of the methodologies discussed herein.

The machine 800 may include processors 810, memory 830, and input/output (I/O) components 850, which may be configured to communicate with each other such as via a bus 802. In an example embodiment, the processors 810 (e.g., Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 812 and a processor 814 that may execute the instructions 816. The term “processor” is intended to include multi-core processor that may comprise two or more independent processors (sometimes referred to as “cores”) that may execute instructions contemporaneously. Although FIG. 8 shows multiple processors, the machine 800 may include a single processor with a single core, a single processor with multiple cores (e.g., a multi-core processor), multiple processors with a single core, multiple processors with multiples cores, or any combination thereof.

The memory/storage 830 may include a memory, such as a main memory 832, a static memory 834, or other memory, and a storage unit 836, both accessible to the processors 810 such as via the bus 802. The storage unit 836 and memory 832, 834 store the instructions 816 embodying any one or more of the methodologies or functions described herein. The instructions 816 may also reside, completely or partially, within the memory 832, 834, within the storage unit 836, within at least one of the processors 810 (e.g., within the processor's cache memory), or any suitable combination thereof, during execution thereof by the machine 800. Accordingly, the memory 832, 834, the storage unit 836, and the memory of processors 810 are examples of machine-readable media 838.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies or operations, including non-routine or unconventional methodologies or operations, or non-routine or unconventional combinations of methodologies or operations, described herein. Accordingly, a “machine-readable medium” refers to a single storage apparatus or device, as well as “cloud-based” storage systems or storage networks that include multiple storage apparatus or devices. The term “machine-readable medium” excludes signals per se.

The input/output (I/O) components 850 may include a wide variety of components to receive input, provide output, produce output, transmit information, exchange information, capture measurements, and so on. The specific input/output (I/O) components 850 that are included in a particular machine will depend on the type of machine. For example, portable machines such as mobile phones will likely include a touch input device or other such input mechanisms, while a headless server machine will likely not include such a touch input device. It will be appreciated that the input/output (I/O) components 850 may include many other components that are not shown in FIG. 8. The input/output (I/O) components 850 are grouped according to functionality merely for simplifying the following discussion and the grouping is in no way limiting. In various example embodiments, the input/output (I/O) components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the input/output (I/O) components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person. (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The input/output (I/O) components 850 may include communication components 864 operable to couple the machine 800 to a network 880 or devices 870 via a coupling 882 and a coupling 872 respectively. For example, the communication components 864 may include a network interface component or other suitable device to interface with the network 880. In further examples, the communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a Universal Serial Bus (USB)).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 862, such as, location via Internet Protocol (IP) geo-location, location via Wi-Fi® signal triangulation, location via detecting a NFC beacon signal that may indicate a particular location, and so forth.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource maybe implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

What is claimed is:

1. A system comprising:
one or more computer processors;
one or more computer memories;
a set of instructions stored in the one or more computer memories, the set of instructions configuring the one or more computer processors to perform operations, the operations comprising:
accessing data describing a curve;
generating one or more circle arc segments that fit the curve, the generating including repeatedly subdividing the curve until a difference between each subdivision of the curve and an associated circle arc segment of the one or more circle arc segments falls below a difference threshold; and
for each generated. circle arc segment, generating a simple polygon that encompasses the circle arc segment.

2. The system of claim 1, the operations further comprising, for each generated circle arc segment, storing data. describing a center and a radius for each circle arc segment within at least one vertex of the simple polygon.

3. The system of claim. 1, wherein, for each circle arc segment, a starting point and an ending point of the arc segment matches with two vertices of the simple polygon.

4. The system of claim 1, further comprising:
determining a set of pixels associated with the rendering of the simple polygon from a plurality of pixels associated with a display; and
for each pixel in the set of pixels, determining a distance between a center of the pixel and an arc center associated with the simple polygon and determining a new distance that represents a difference between the distance and an arc radius associated with the simple polygon.

5. The system of claim 4, the operations further comprising, for each pixel in the set of pixels, based on an analysis of a sign and magnitude of the new distance in relation to a distance threshold, determining the pixel as being inside the curve and flagging the pixel as to be rendered.

6. The system of claim 4, the operations further comprising, for each pixel in the set of pixels, based on an absolute value of the new distance being less than a distance threshold, flagging the pixel as being partially covered by the curve and modifying an alpha value associated with the pixel to represent a blending of the pixel near an edge of the curve.

7. The system of claim 4, the operations further comprising, for each pixel in the set of pixels, based on an analysis of a sign and magnitude of the new distance, and a comparison of the same to a distance threshold, determining the pixel as being outside of the curve and flagging the pixel as not to be rendered.

8. The system. of claim 1, wherein the curve has a line thickness outlining an object to be rendered as a line drawing, and the operations further comprising, for each generated circle arc segment, storing data describing a center, an inner radius, and an outer radius for each circle arc segment within at least one vertex of the simple polygon.

9. The system of claim 8, further comprising:
determining a set of pixels associated with a rendering of the simple polygon from a plurality of pixels associated with a display;
for each pixel in the set of pixels, determining a distance between a center of the pixel and an arc center associated with the simple polygon and comparing the distance to the inner radius and outer radius associated with the simple polygon; and
determining the pixel as being inside the curve based on the comparison, and flagging the pixel as to be rendered.

10. The system of claim 9, the operations further comprising, for each pixel in the set of pixels, based on the comparison determining that the pixel is within a distance threshold of the inner radius or outer radius, flagging the pixel as being partially covered by the curve and modifying an alpha value associated with the pixel to represent a blending of the pixel near an edge of the curve.

11. A non-transitory computer-readable storage medium storing a set of instructions, the set of instructions configuring one or more computer processors to perform operations, the operations comprising:
accessing data describing a curve;
generating one or more circle arc segments that fit the curve, the generating including repeatedly subdividing the curve until a difference between each subdivision of the curve and an associated circle arc segment of the one or more circle arc segments falls below a difference threshold; and
for each generated circle arc segment, generating a simple polygon that encompasses the circle arc segment.

12. The non-transitory computer-readable storage medium of claim 11, the operations further comprising, for each generated circle arc segment, storing data describing a center and a radius for each circle arc segment within at least one vertex of the simple polygon.

13. The non-transitory computer-readable storage medium of claim 11, wherein, for each circle arc segment, a starting point and an ending point of the arc segment matches with two vertices of the simple polygon.

14. The non-transitory computer-readable storage medium of claim 11, the operations further comprising:
determining a set of pixels associated with the rendering of the simple polygon from a plurality of pixels associated with a display; and
for each pixel the set of pixels, determining a distance between a center of the pixel and an arc center associated with the simple polygon and determining a new distance that represents a difference between the distance and an arc radius associated with the simple polygon.

15. The non-transitory computer-readable storage medium of claim 14, the operations further comprising, for each pixel in the set of pixels, based on an analysis of a sign and magnitude of the new distance in relation to a distance threshold, determining the pixel as being inside the curve and flagging the pixel as to be rendered.

16. The non-transitory computer-readable storage medium of claim 14, operations further comprising, for each pixel in the set of pixels, based on an absolute value of the new distance being less than a distance threshold, flagging the pixel as being partially covered by the curve and modifying an alpha value associated with the pixel to represent a blending of the pixel near an edge of the curve.

17. The non-transitory computer-readable storage medium of claim 14, the operations further comprising, for each pixel in the set of pixels, based on an analysis of a sign and magnitude of the new distance, and a comparison of the same to a distance threshold, determining the pixel as being outside of the curve and flagging the pixel as not to be rendered.

18. A method comprising:
accessing data describing a curve;
generating one or more circle arc segments that fit the curve, the generating including repeatedly subdividing the curve until a difference between each subdivision of the curve and an associated circle arc segment of the one or more circle arc segments falls below a difference threshold; and
for each generated circle arc segment, generating a simple polygon that encompasses the circle arc segment.

19. The method of claim 18, further comprising, for each generated circle arc segment, storing data describing a center and a radius for each circle arc segment within at least one vertex of the simple polygon.

20. The method of claim 18, wherein, for each circle arc segment, a starting point and an ending point of the arc segment matches with two vertices of the simple polygon.
